(19) United States
(12) Patent Application Publication
(10) Pub. No.: US 2026/0005846 A1
(43) Pub. Date: Jan. 1, 2026

(54) MESH NETWORK COMMUNICATIONS

(71) Applicant: Wells Fargo Bank, N.A., San Francisco, CA (US)

(72) Inventors: Peter Burton Bordow, Fountain Hills, AZ (US); Rameshchandra Bhaskar Ketharaju, Hyderabad (IN); Michael Erik Meinholz, Charlotte, NC (US); Abhijit Rao, Irvine, CA (US); Tahereh Rezaei, Charlotte, NC (US); Bradford A. Shea, Mint Hill, NC (US); Jeff J. Stapleton, Fort Worth, TX (US)

(21) Appl. No.: 18/756,371

(22) Filed: Jun. 27, 2024

(51) Int. Cl. H04L 9/08

(52) U.S. Cl. CPC H04L 9/0869

(57) ABSTRACT

A mesh communication network for providing random bits for key generation may comprise one or more network nodes. Random bitstreams may be generated by nodes in the network based upon environmental conditions, hardware in the node, quantum phenomena, and the like. In some examples, the system can generate a common set of random bits from a superset of bits and deliver the common set or the superset to communicating parties which can then be used by the communicating parties to generate a shared cryptographic key.

### TECHNICAL FIELD

Embodiments of the present invention relates to the field of secure communications and, more particularly, to methods and systems for securely communicating information, such as transmitting random bits that can be used to generate cryptographic keys through a mesh network comprising satellites and other stations (such as ground-based stations, mobile stations, or the like).

### BACKGROUND

Secure communication systems rely on the use of cryptographic keys to encrypt and decrypt messages. The security of these systems is contingent upon the secure generation, distribution, and management of these keys. Conventional key distribution methods are vulnerable to interception and require secure channels for the exchange of keys, which can be a significant limitation in practice. The generation of cryptographic keys often involves the use of random bit generators. However, many sources of randomness, such as CPU usage or other deterministic processes, may not be truly random and can be vulnerable to prediction or manipulation. Furthermore, the transmission of cryptographic keys or random bitstrings over long distances poses additional challenges. Signal loss, interference, and the need for a direct line of sight between communication nodes such as satellites, can hinder the effectiveness of key distribution systems.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a schematic diagram illustrating an example of a mesh communication network for the secure transmission of random bitstrings for cryptographic purposes, according to some examples of the present disclosure.

FIG. 2 presents a logical diagram of example functional components of a mesh node and a communicating party.

FIG. 3 is a flowchart of method for distributing random bitstrings within a mesh network for the purpose of cryptographic key generation.

FIG. 4 is a block diagram illustrating an example of a machine upon which one or more embodiments may be implemented.

### DETAILED DESCRIPTION

Disclosed in some examples are methods, devices, systems, and machine-readable mediums for the secure transmission of information through a mesh communication network. The mesh communication network may comprise one or more nodes comprising geosynchronous Earth orbit (GEO) satellites, low Earth orbit (LEO) satellites, high-altitude units (HAUs), lunar-based stations, and/or terrestrial stations. The use of a mesh network enables communications between nodes in the mesh without requiring line-of-sight when methods of communication such as optical communications are used. In addition, in some examples, the mesh may collaboratively generate one or more random bits that may be used, e.g., to generate one or more cryptographic keys that may be used for example in communications. The use of multiple nodes to generate the random bitstreams may facilitate more secure generation of random bitstrings and thus more secure communication keys by increasing the entropy of those random bitstrings.

In some examples, the mesh nodes may collectively generate the random bitstring e.g., by using cryptopgraphically strong random bitstream generators within the mesh nodes that use a seed value with a high entropy. Example entropy sources include environmental conditions, hardware in the node, quantum phenomena, and the like. The random bitstring may be used to create one or more cryptographic keys. These random bitstrings or keys may be used by the mesh nodes to communicate and/or may be delivered to and used by mesh nodes or non-mesh node communicating parties to communicate. For example, a mobile device may receive the random bits, generate a key using those bits, and communicate with another party that also receives the random bits and is able to independently generate a matching key. This provides for enhanced key distribution security.

In some examples, the random bitstring may be used for purposes other than generating keys for communication. For example, to generate a random bitstring for a Hashed Message Authentication Code (HMAC), One-Time Passcode (OTP) for a transaction, or for various computer-generated simulations that may utilize randomness.

In some examples, two or more mesh nodes may utilize Quantum Key Distribution techniques to securely communicate the random bitstreams and/or keys between each mesh node. Each node may then independently generate the same key which may be communicated to communicating parties. Communicating parties may be one or more nodes in the mesh or may be other devices.

The mesh network may employ radio communications, quantum techniques such as quantum entanglement, photonic communication, light-based communications (e.g., laser), and the like to communicate securely between the mesh nodes. Due to the mesh nature of the network, line-of-sight between satellites may not be necessary between each satellite in the network. This enhances security by making the bitstring generation harder to intercept using person-in-the-middle attacks. The key generation process may be periodic so that communications are re-secured in case a single key is compromised. In some examples and as already noted, the random bitstrings may be used by the mesh nodes, or the key may be provided to non-mesh communicating party devices for use in their communications—e.g., for highly secure financial transactions or the like. The key generation and communication process may be facilitated by one or more control nodes, such as terrestrial nodes which may control the quantum sensors on other nodes.

In some examples, some nodes in the mesh may be relay nodes that relays random bits to other nodes. In other examples, some nodes may be both a relay and generating node that in addition to relaying random bits, may add additional random bits to other received random bits from other nodes (or starts the sequence) to create a larger set of random bits. By leveraging the mesh network to relay communications, such as the aforementioned random bits, the invention provides a robust solution for secure communication that provides sufficient security for communicating parties that bypass some of the limitations of key generation and distribution and solve the issue of needing a line-of sight to communicate (e.g., for quantum key distribution or for optical communication methods).

The mesh system may periodically generate a random bitstream or keys and transmit them amongst the nodes and to communicating parties. In other examples, one or more of the non-mesh communicating parties or mesh nodes may request the random bitstream from one or more nodes in the system. The random bitstream or the key may then be delivered to the requesting party, or to all of the communicating parties. In examples in which random bitstream are delivered, the random bitstream may comprise the key, or be used to create a key. In still other examples, a control node may control the creation and distribution of new random bitstreams, keys, or the like. In some examples, each bitstream may have associated metadata such as an identifier, a creation date, or the like to manage a time-to-live. In some examples, the metadata may include a version number that is incremented or changed each time a node adds bits to the bitstream.

The formation of the mesh network may begin with the execution of a discovery protocol. This protocol enables nodes to detect the presence of other nodes within their communication range. This may be based upon broadcast discovery messages that are then replied to by nodes that receive the broadcast discovery messages, creating a communication channel between nodes. Nodes may exchange information such as signal strength, various costs associated with the node (such as cost to traverse and cost to use the node), routing information (including routing costs), node capacity, and capability data, including available bandwidth and power resources. This exchange of information allows the mesh network to optimize its topology, ensuring efficient routing of data and distribution of random bits across the network. For example, the nodes may build one or more routing tables using the shared cost information.

To maintain the integrity and robustness of the mesh network, a reconfiguration protocol may be implemented. This protocol monitors the operational status of the nodes and, in the event of a node failure or communication disruption, calculates alternative routes for data transmission. The reconfiguration protocol may utilize a consensus mechanism among neighboring nodes to collaboratively select new routing paths, and may consider factors such as network load, node energy levels, node costs, costs of losing the node to existing links (i.e., the recacluation) and historical reliability data. Example discovery, routing, and maintenance protocols may include Better Approach to Mobile Ad Hoc Networking (BATMAN) and Optimized Link State Routing (OLSR). Both of these protocols enable the self-discovery and self-configuration capabilities that allow mesh networks to function.

In some examples, nodes may exchange routing information. For example, each node may be associated with a cost of traversing and using that node. When a node is lost or a node is discovered—the initial routing and the rerouting algorithms may consider these costs. Further, when there are multiple routes available these costs will be factored in to decide which route to be used to generate the cryptographic keys or make available random bitstrings.

Nodes within the mesh network may use directional communications, such as directional antennas and optical transmitters to establish focused communication beams to enhance the security and reliability of data transmission. Additionally, the network may incorporate techniques such as frequency hopping or spread-spectrum communications to reduce risks of jamming and interception and increase the likelihood successful communications. To ensure synchronization across the mesh network, a time synchronization protocol may be employed. This protocol aligns the clocks of the nodes, which is critical for coordinating actions such as the selection of random bits for cryptographic key generation and the timing of secure communications. An example time synchronization protocol may be a Network Time Protocol (NTP).

To generate a string of random bits, each node may periodically generate random bits and communicate them to the other nodes in the network, or to a control node. The entire random bitstream sequence may be provided or transmitted to communicating parties (mesh or non-mesh communicating parties), who may select a sub-sequence of these bits to use to create a key. In other examples, a control node may select a subset of mesh nodes to contribute to the random bitstream sequence at a particular time. The control node may command the nodes that are designated to contribute to the random sequence to generate a number of random bits. The nodes then reply with the requested number of random bits. The control node may order these bits in a particular fashion and provide the ordered bits to one or more of the nodes who may broadcast the bits or send the bits directly to communicating parties (either mesh or non-mesh communicating parties).

Nodes selected for contributing to the random sequence may be selected randomly, or based upon a weighted selection that may consider one or more factors such as:
Node Capability and Status: Nodes may be selected based on their current operational status, available resources (like computational power and battery life), and their capability to generate high-quality random bits.
Cost: Nodes may be selected based upon the resource cost of traversing and/or utilizing the node.
Network Topology: The physical layout and connectivity of the network can be used to select which nodes are chosen to generate and send random bits. Nodes that have a strong, stable connection to others may be preferred.
Security Considerations: Nodes with enhanced security features or those located in more secure environments might be prioritized for generating random bits to reduce the risk of interception or manipulation. In some examples, two different nodes that are not within a line of sight of each other may be utilized to prevent eavesdropping.

These factors may be utilized with one or more rules that score each node based upon one or more of these factors. The scores may then be weighted and combined to produce a total score. The nodes with the highest scores may be selected to generate the random bits.

In some examples, the random bits of each node may be combined in a number of ways, such as:
Concatenation: Each node's bits may be concatenated to form a longer bit string. This can be done by simply appending the bits from one node to those from another.
XOR Operation: A more sophisticated method involves performing a bitwise exclusive OR (XOR) operation on the random bits from different nodes. The XOR of two random bitstreams will also be random if at least one of the strings is random.
Hash Functions: Nodes can use cryptographic hash functions to combine random bits. Multiple bitstreams can be input into a hash function to produce a fixed-size output that appears random.
Entropy Pooling: Nodes can contribute their random bitstreams to a shared entropy pool. A cryptographic algorithm can then draw from this pool to produce random bits for the bitstreams.
Other Functions: Bits may be combined using other functions, such as a Key Derivation Function (KDF), Random Bit Generators (e.g., using the current bit sequence as a seed to a pseudorandom function), and the like.

In examples in which the communicating parties independently select a subset of the random bitstream to use in creating a common communication key, the method used may use one of the following methods.

Secure Delivery—If the delivery of random bits to the communicating parties is secured (e.g., via Quantum Key Distribution or an encrypted channel), the parties can use the following methods:
Pre-Agreed Protocol: The parties could use a pre-agreed protocol to select which bits to use. For example, they might agree to always use the first 256 bits received after a certain time or event.
Index List: The parties could agree on a list of indices beforehand, during a secure setup phase, which would indicate which bits from the bitstring to use for the key.
Hash Function: Both parties could apply a cryptographic hash function to the entire pool of random bits and use the output as their key, or to determine which bits to use as their key.

Unsecure Delivery—If the delivery of random bits is not secured with other mechanisms, the parties may use methods that ensure secrecy even if an adversary can observe or tamper with the bit stream:
Interactive Key Agreement Protocol: The parties could use an interactive key agreement protocol like Diffie-Hellman to agree on a key. They could then use this key to encrypt the selection of random bits from the bitstream, ensuring that only someone with the key could know which bits were selected.
Pre-Shared Keys: If both parties have pre-shared keys they could use it to encrypt their selections of bits. This would ensure that only the other party could decrypt and see the selection.
Key Encapsulation Method (KEM): The parties could encrypt their selections with the other party's key, ensuring that only the holder of the corresponding key could decrypt the selection.
Quantum States: Two communicating parties may use entangled photons, where the measurements of these photons by both parties determine the bits to use.

In some examples, the system may generate multiple random bitstream sets and nodes or communicating parties may not receive all of the bitsets. In these examples, the key may be determined from the set of common sets that are received by the nodes. For example, if the system generates a dozen bitstream sets, call them shares 1-12, but not all nodes get all twelve, e.g., node 1 gets shares 1-6, node 2 gets shares 2-7, node 3 gets 3-8, then shares 3-6 may be used for nodes 1, 2, 3 to determine the same key.

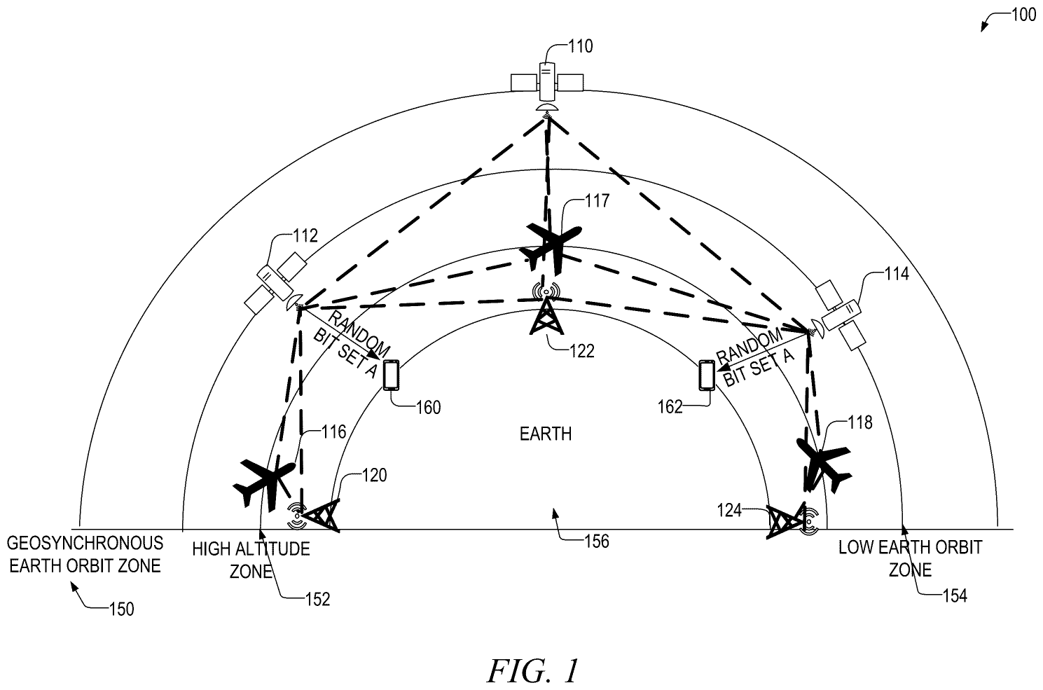

FIG. 1 is a schematic diagram illustrating an example of a mesh communication network 100 for the secure transmission of random bits for cryptographic purposes, according to some examples of the present disclosure. The Earth 156 is depicted at the center of FIG. 1, surrounded by three concentric rings representing different zones where network nodes may be present. The innermost ring represents the High Altitude (HA) Zone 152, the middle ring represents the Low Earth Orbit (LEO) zone 154, and the outermost ring represents the Geosynchronous Earth Orbit (GEO) zone 150. Mesh nodes such as satellites 110, 112, 114, airplanes 116, 117, 118, and radio towers 120, 122, and 124 may be positioned throughout the various zones, such as shown in FIG. 1. In some examples, and not shown for clarity, mesh nodes may be stationed on other celestial bodies, such as the moon or other planets.

In the GEO zone 150, a satellite 110 is positioned, and may be in geostationary orbit to maintain a constant geostationary position relative to the Earth 156. The satellite 110 is capable of communicating with other nodes within its line of sight, including satellites 112 and 114 in the LEO zone 154, airplane 117 in the HA zone 152, and radio tower 122 on the surface of the Earth 156.

Within the LEO zone 154, satellites 112 and 114 orbit the Earth 156 at lower altitudes compared to the GEO satellite 110. Satellite 112 has communication links with airplanes 116 and 117, radio towers 120 and 122, and the GEO satellite 110. Similarly, satellite 114 can communicate with satellite 110, airplane 118, airplane 117, and radio towers 122 and 124. Nodes that are not in direct communication may still communicate across the mesh communication network 100. For example, satellite 112 may communicate with radio tower 124 through a number of paths, such as through radio tower 122 to satellite 114, to radio tower 124.

The HA zone 152 contains airplanes 116, 117, and 118, which are high-altitude nodes capable of moving dynamically through this zone. Airplane 116 can communicate with radio tower 120 and satellite 112. Airplane 117 has communication capabilities with radio tower 122, satellites 112, 110, and 114. Airplane 118 is able to communicate with radio tower 124 and satellite 114. Airplanes may be manned or unmanned. On the surface of the Earth 156, radio towers 120, 122, and 124 serve as terrestrial stations for the mesh network. These towers are equipped to communicate with various nodes in the LEO zone 154 and HA zone 152, as well as directly with the GEO satellite 110. In addition to stationary terrestrial stations, the mesh may be made up of moving terrestrial stations, such as user devices like cellphones, automobiles, ships, airplanes below the HA zone 152, and the like.

As nodes in FIG. 1 move, the relationships and visibility of each node may shift and change as the nodes change positions. The reconfiguration protocol keeps a routing table up to date to ensure that communications are possible even as nodes move.

In some examples, the LEO zone 154 includes altitudes typically between 160 and 1,000 km (99 and 621 miles) above the Earth's surface. The GEO zone 150 may comprise both the Medium Earth Orbit (MEO) which includes altitudes between 5,000 and 20,000 km (3,100 and 12,400 miles) above the Earth's surface and the High Earth Orbit (HEO) which includes altitudes from MEO to approximately 35,786 km (22,236 miles) above the Earth's surface. The HA zone 152 in some examples may be the zone between approximately 8,000 feet from the earth's surface to the LEO zone 154. Any station below the HA zone 152 may be considered a terrestrial station. Terrestrial stations may include ground-based units such as radio towers, but may also include small planes, ships, low flying balloons, and other objects.

Communicating party 160 is shown receiving a random bitstream A from satellite 112, while communicating party 162 receives the same random bitstream A from satellite 114. The random bitstream A is part of a distributed pool of random bitstreams generated within the mesh network by one or more of the nodes of the mesh network and is used by communicating parties 160 and 162 to independently generate a cryptographic key for establishing a secure communication channel. The communicating parties independently create the cryptographic key using the same bitstream received from the mesh network with a key-derivation function. As previously noted, the communicating parties may be mesh nodes, or may not be mesh nodes. In some examples, all the nodes in FIG. 1 receive the random bits and/or keys and use those bits to generate keys that they then use to communicate amongst the mesh nodes.

In the mesh communication network, random bit set A may be generated through a collaborative process involving various nodes, including geosynchronous Earth orbit (GEO) satellites, low Earth orbit (LEO) satellites, platform in motion (PIM) units such as airplanes, and terrestrial stations like radio towers. In some examples, nodes in the network, such as GEO satellite 110, LEO satellites 112 and 114, and PIM units like airplanes 116, 117, and 118, may be equipped with random bitstream generators. These devices generate initial random bits by measuring various environmental factors or quantum phenomena, ensuring that the bits are unpredictable and suitable for cryptographic use. In some examples, quantum phenomena may include photon polarization, entanglement, spin, phase, energy levels, and the like.

The nodes generate random bits as previously described and communicate these bits with each other to share the initially generated random bits. For example, GEO satellite 110 may transmit a portion of its generated random bits to LEO satellite 112, which in turn may pass some of these bits along with its own to airplane 116. As the random bits are transmitted across the network, they are pooled together to form a larger set of random bits in a bitstream. This pooling may occur at various stages within the network, such as at a particular satellite or airplane that acts as a collection point. From the pooled random bits, a subset may be selected to form random bitstream A. The selection process may be based on pre-defined protocols, ensuring that the bits chosen are distributed evenly and represent the collective randomness of the entire network.

Before finalizing random bitstream A, in some examples, error checking and correction protocols are applied to ensure that any transmission errors are identified and corrected, maintaining the integrity of the random bits. Once random bit set A is generated and verified, it is distributed to the communicating parties. For example, LEO satellite 112 transmits random bit set A to communicating party 160, while LEO satellite 114 transmits the same random bit set A to communicating party 162. To ensure that both communicating parties 160 and 162 receive the same random bit set A, synchronization signals may be used across the network. These signals coordinate the timing of transmission from the nodes to the parties, ensuring that the random bits are consistent and can be used to generate a shared cryptographic key.

As previously noted, in some examples, the communicating parties themselves may select the subset of random bits to use in generating a key. When generating the key, the parties may utilize a key derivation function (KDF). The KDF is a cryptographic algorithm that takes an input (the random bit set A) and produces a fixed-size output (the cryptographic key). The KDF may incorporate additional inputs, such as initial keying material, a nonce or salt, to enhance security. Example KDFs may include Password-Based Key Derivation Function 2, BCrypt, Scrypt, Argon2, and the like.

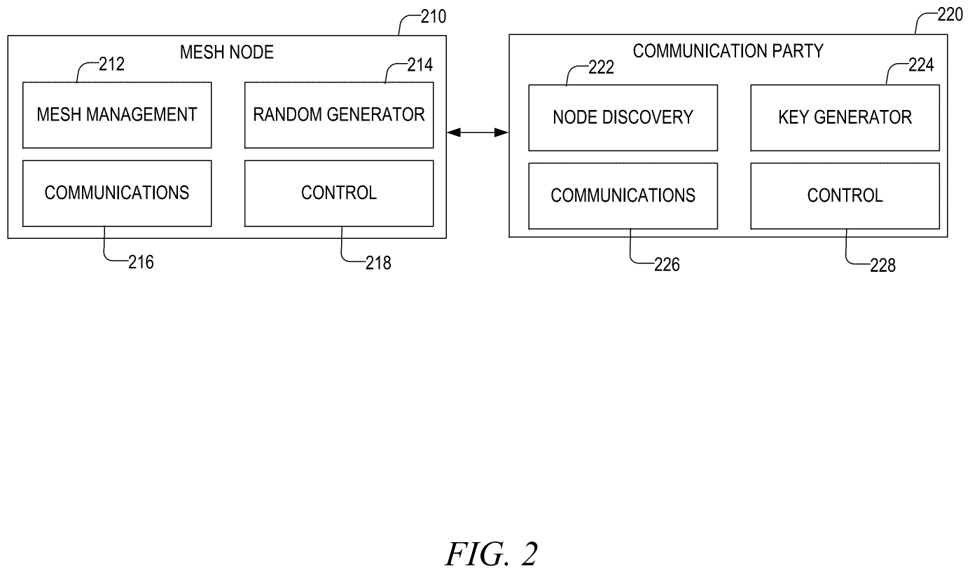

FIG. 2 presents a logical diagram of example functional components of a mesh node 210 and a communicating party 220. The mesh node 210 is equipped with a mesh management component 212, which is tasked with the formation and ongoing modification of the mesh network. This component executes the mesh network protocols that identify and connects with other nodes, adapts the network's structure to accommodate changes such as node additions or failures, and uses the knowledge of the mesh network to assist in creating routing tables that are used to route communications across the mesh network. Random bitstream generator component 214 produces random bitstreams that are used by communicating parties, such as communicating party 220, for the creation of cryptographic keys. These numbers may be generated to ensure true randomness, such as by utilizing quantum phenomena. The random bitstream generator component 214 may include access to a source of entropy.

Communications within the mesh network are facilitated by the communications component 216, which manages the exchange of random bitstreams, synchronization signals, and other data between mesh nodes and communicating parties. The communications component 216 may manage communications through radio, optical, quantum (e.g., quantum entanglement), and other means and may implement one or more communication protocols such as Transmission Control Protocol/Internet Protocol (TCP/IP), User Datagram Protocol (UDP), or the like. Communication between nodes in the mesh network may be secured using encryption protocols such as AES-256 (for symmetric-key encryption) or RSA-4096 (for public-key encryption).

The control component 218 within the mesh node 210 oversees the generation and distribution of random bitstreams. It also handles the forwarding and concatenation of random bitstreams from other nodes.

The communicating party 220 is a computing device that leverages the mesh network for secure communication through the use of cryptographic keys derived from the random bitstreams supplied by the mesh nodes. In some examples, the communicating party 220 may be a mesh node and may include the components of mesh node 210. The communicating party 220 features a node discovery component 222, which allows it to locate mesh nodes capable of providing the random bitstreams needed for cryptographic functions. The communications component 226 enables the communicating party 220 to engage with mesh nodes and other communicating parties, receiving the random bitstreams that are used by the key generation process. The communications component 226 may communicate through optical, radio, quantum, and other methods and may implement one or more communication protocols such as Transmission Control Protocol/Internet Protocol (TCP/IP), User Datagram Protocol (UDP), or the like.

The key generator component 224 within the communicating party 220 utilizes the received random bitstrings to generate cryptographic keys, which are then employed to encrypt and decrypt communications, establish secure channels, and support various cryptographic operations. The control component 228 is responsible for the oversight of the key generation process, ensuring the proper use of received random bitstreams and the secure management of the generated keys.

One or more of the mesh nodes, such as mesh node 210 may communicate with a communication party 220 (which may be another mesh node) through various means to communicate the random bits or keys for use in communicating with other communication parties. Example methods of communication may include wired, wireless (e.g., Radio Frequency), quantum, optical, and the like.

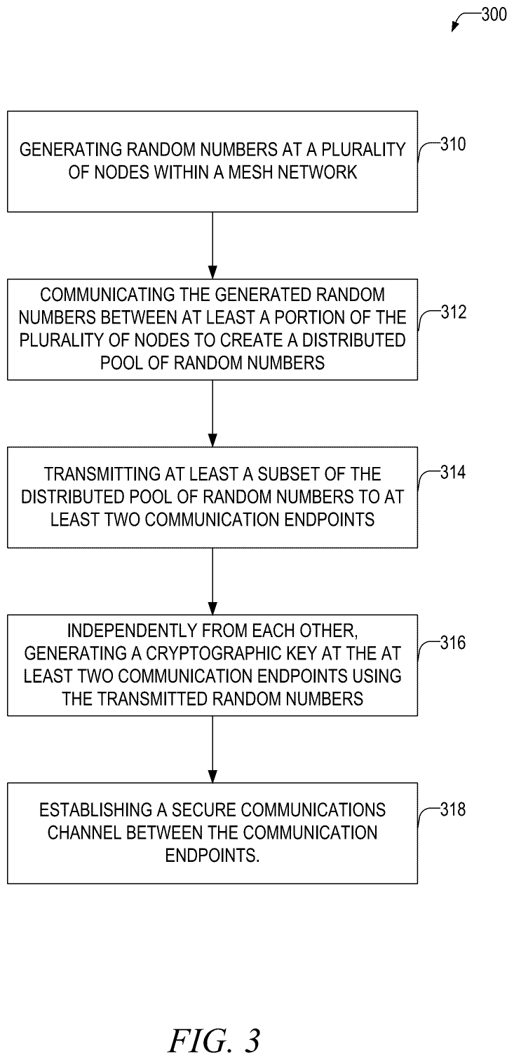

FIG. 3 is a flowchart of method 300 for distributing random bitstreams within a mesh network for the purpose of cryptographic key generation. At operation 310, the system generates random bitstreams at a plurality of nodes within the mesh network. These nodes may be diverse in nature, potentially encompassing one or more terrestrial stations; satellites; or aircraft (e.g., airliners), unmanned aerial vehicles, airships, balloons, drones and the like. As used herein, aircraft (manned or unmanned), unmanned aerial vehicles, airships, balloons, drones, and the like that are used as nodes in the mesh network are herein referred to as High-Altitude Platform Stations (HAPS). Random bitstreams may be generated using pseudo random bitstream generators with seed values based upon hardware measurements (e.g., temperatures of components, disk and network I/O, and the like), physical environment measurements (e.g., temperature, quantum measurements, radioactive decay, atmospheric noise, and the like), and the like.

Moving to operation 312, each node communicates the generated random bitstreams between other selected nodes in the mesh network. This communication facilitates the creation of a distributed pool of random bitstreams, which is a collective resource within the mesh network that enhances the security and reliability of the cryptographic keys to be generated.

Next, at operation 314, the system transmits at least a subset of this distributed pool of random bitstreams to at least two communication endpoints. This transmission provides the necessary random bitstreams that will be used by the communication endpoints to independently generate cryptographic keys. At operation 316, each communication endpoint independently from each other generates a cryptographic key using the subset of random bitstreams received. This independent generation ensures each endpoint is equipped with a cryptographic key derived from the same random bitstreams, enabling the possibility of secure communication. In some examples, independent generation may comprise each communicating party generating, by itself, a key from the random bits or chosen subset (either chosen by the network or through some agreements or communications among communicating parties) using a cryptographic key derivation function. Communication endpoints may be mesh nodes, or may be non-mesh nodes.

In some examples, the mesh network may generate the key using the random bitstreams. For example, a control node or a randomly chosen node may generate the key and then communicate the key to one or more other mesh nodes that then may communicate the key to the communicating parties. In some examples, the communicating parties may be one or more of the mesh nodes.

Finally, at operation 318, the system establishes a secure communication channel between the at least two communication endpoints utilizing the independently generated cryptographic keys. This secure channel represents the successful outcome of the process, allowing for encrypted and secure exchanges between the endpoints.

The operations 310, 312, and 314 may be done continually and the random bitstreams broadcast to communicating parties. In other examples, the operations 310, 312, and 314 may be done in response to a request for random bitstreams. In some examples, the mesh network may authenticate random bitstream recipients. For example, using username and passwords, two-factor authentication and the like. In some examples, the random sequence sent to the communicating parties may be required to have random bitstreams provided by non-line-of-sight nodes in the mesh network to protect against person-in-the-middle attacks. Usages of the random bits described herein may include financial transactions, remote sensing, autonomous vehicle coordination, disaster response communications, and secure sensitive communications. The versatility of the network allows it to be adapted for a wide range of use cases requiring robust and secure data transmission.

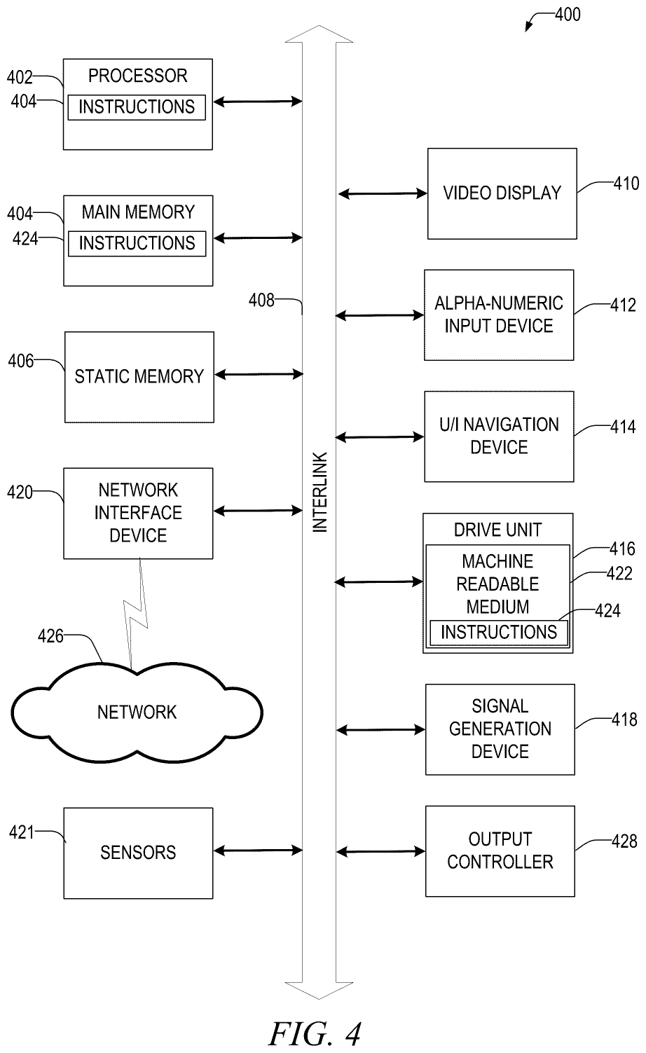

FIG. 4 illustrates a block diagram of an example machine 400 upon which any one or more of the techniques (e.g., methodologies) discussed herein may be performed. In alternative embodiments, the machine 400 may operate as a standalone device or may be connected (e.g., networked) to other machines. In a networked deployment, the machine 400 may operate in the capacity of a server machine, a client machine, or both in server-client network environments. In an example, the machine 400 may act as a peer machine in peer-to-peer (P2P) (or other distributed) network environment. The machine 400 may be in the form of a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. In some examples, the machine 400 may be a mesh node, a communicating party, and may be configured to perform the operations of FIG. 3.

While the examples herein may have used the example of generating random bitstreams for generation of cryptographic keys that are used for communications, other random bitstream usages may include keys for encryption (which may be used for communications, security of data at rest, or the like), key generation for MAC or HMAC, authentication tokens, one-time passcodes, simulation processes, and the like.

Examples, as described herein, may include, or may operate on one or more logic units, components, or mechanisms (hereinafter “components”). Components are tangible entities (e.g., hardware) capable of performing specified operations and may be configured or arranged in a certain manner. In an example, circuits may be arranged (e.g., internally or with respect to external entities such as other circuits) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine readable medium. In an example, the software, when executed by the underlying hardware of the component, causes the hardware to perform the specified operations of the component.

Accordingly, the term “component” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which component are temporarily configured, each of the components need not be instantiated at any one moment in time. For example, where the components comprise a general-purpose hardware processor configured using software, the general-purpose hardware processor may be configured as respective different components at different times. Software may accordingly configure a hardware processor, for example, to constitute a particular module at one instance of time and to constitute a different component at a different instance of time.

Machine (e.g., computer system) 400 may include one or more hardware processors, such as processor 402. Processor 402 may be a central processing unit (CPU), a graphics processing unit (GPU), a hardware processor core, or any combination thereof. Machine 400 may include a main memory 404 and a static memory 406, some or all of which may communicate with each other via an interlink (e.g., bus) 408. Examples of main memory 404 may include Synchronous Dynamic Random-Access Memory (SDRAM), such as Double Data Rate memory, such as DDR4 or DDR5. Interlink 408 may be one or more different types of interlinks such that one or more components may be connected using a first type of interlink and one or more components may be connected using a second type of interlink. Example interlinks may include a memory bus, a peripheral component interconnect (PCI), a peripheral component interconnect express (PCIe) bus, a universal serial bus (USB), or the like.

The machine 400 may further include a display unit 410, an alphanumeric input device 412 (e.g., a keyboard), and a user interface (UI) navigation device 414 (e.g., a mouse). In an example, the display unit 410, input device 412 and UI navigation device 414 may be a touch screen display. The machine 400 may additionally include a storage device (e.g., drive unit) 416, a signal generation device 418 (e.g., a speaker), a network interface device 420, and one or more sensors 421, such as a global positioning system (GPS) sensor, compass, accelerometer, or other sensor. The machine 400 may include an output controller 428, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 416 may include a machine readable medium 422 on which is stored one or more sets of data structures or instructions 424 (e.g., software) embodying or utilized by any one or more of the techniques or functions described herein. The instructions 424 may also reside, completely or at least partially, within the main memory 404, within static memory 406, or within the hardware processor 402 during execution thereof by the machine 400. In an example, one or any combination of the hardware processor 402, the main memory 404, the static memory 406, or the storage device 416 may constitute machine readable media.

While the machine readable medium 422 is illustrated as a single medium, the term “machine readable medium” may include a single medium or multiple media (e.g., a centralized or distributed database, and/or associated caches and servers) configured to store the one or more instructions 424.

The term “machine readable medium” may include any medium that is capable of storing, encoding, or carrying instructions for execution by the machine 400 and that cause the machine 400 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 424 may further be transmitted or received over a communications network 426 using a transmission medium via the network interface device 420. The Machine 400 may communicate with one or more other machines wired or wirelessly utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks such as an Institute of Electrical and Electronics Engineers (IEEE) 802.11 family of standards known as Wi-Fi®, an IEEE 802.15.4 family of standards, a 5G New Radio (NR) family of standards, a Long Term Evolution (LTE) family of standards, a Universal Mobile Telecommunications System (UMTS) family of standards, peer-to-peer (P2P) networks, among others. In an example, the network interface device 420 may include one or more physical jacks (e.g., Ethernet, coaxial, or phone jacks) or one or more antennas to connect to the communications network 426. In an example, the network interface device 420 may include a plurality of antennas to wirelessly communicate using at least one of single-input multiple-output (SIMO), multiple-input multiple-output (MIMO), or multiple-input single-output (MISO) techniques. In some examples, the network interface device 420 may wirelessly communicate using Multiple User MIMO techniques.

### OTHER NOTES AND EXAMPLES

Example 1 is a method for distributing random bitstreams for cryptographic key generation within a mesh network, the method comprising: generating random bitstreams at a plurality of nodes within the mesh network, wherein the plurality of nodes comprises at least two of the following types: terrestrial stations, satellites, or high-altitude aircraft; communicating the generated random bitstreams between the plurality of nodes to create a distributed pool of random bitstreams within the mesh network; transmitting at least a subset of the distributed pool of random bitstreams to at least two communication endpoints; independently from each other, generating a cryptographic key at the at least two communication endpoints using the transmitted at least a subset of the distributed pool of random bitstreams; and establishing a secure communication channel between distributing random bitstringsthe at least two communication endpoints using the generated cryptographic key.

In Example 2, the subject matter of Example 1 includes, wherein a first and second of the at least two communication endpoints are satellites in geosynchronous orbit and are both nodes in the mesh network.

In Example 3, the subject matter of Examples 1-2 includes, wherein the generating of random bitstreams at the plurality of nodes comprises using quantum phenomena.

In Example 4, the subject matter of Example 3 includes, wherein communicating the generated random bitstreams comprises using quantum key distribution protocols to securely transmit the random bitstreams between nodes.

In Example 5, the subject matter of Examples 1-4 includes, wherein the method further comprises selecting, at the communication endpoints, a subset of the distributed pool of random bitstreams to use in generating a cryptographic key based on synchronization signals within the mesh network.

In Example 6, the subject matter of Examples 1-5 includes, encrypting the transmitted at least a subset of the distributed pool of random bitstreams using a previously established secure channel before sending to the communication endpoints.

In Example 7, the subject matter of Examples 1-6 includes, wherein the mesh network comprises a combination of geosynchronous Earth orbit (GEO) satellites and low Earth orbit (LEO) satellites.

In Example 8, the subject matter of Examples 1-7 includes, wherein the mesh network utilizes frequency hopping or spread-spectrum communication techniques.

In Example 9, the subject matter of Examples 1-8 includes, wherein the cryptographic key generated at the communication endpoints is a symmetric key used for encrypting and decrypting messages.

In Example 10, the subject matter of Examples 1-9 includes, wherein the secure communication channel established is used for financial transactions.

In Example 11, the subject matter of Examples 1-10 includes, wherein the mesh network comprises high-altitude balloons, airplanes or drones.

In Example 12, the subject matter of Examples 1-11 includes, wherein the mesh network is configured to automatically establish connections between nodes by executing a discovery protocol that identifies neighboring nodes based on signal strength and node capacity.

In Example 13, the subject matter of Example 12 includes, wherein the discovery protocol comprises broadcasting beacon signals from nodes, with other nodes responding to the beacons to establish bidirectional communication links based on received signal quality indicators.

In Example 14, the subject matter of Examples 12-13 includes, wherein the discovery protocol further comprises an exchange of node capability data, including available bandwidth and power resources.

In Example 15, the subject matter of Examples 1-14 includes, wherein the mesh network is configured to execute a reconfiguration protocol that reroutes data transmission paths in response to node unavailability, maintaining network connectivity by identifying alternative pathways through operational nodes.

In Example 16, the subject matter of Example 15 includes, wherein the reconfiguration protocol comprises monitoring an operational status of the nodes within the mesh network, and responsive to determining that a first node is not operation or cannot be communicated with, calculating an alternative route that does not include the first node.

In Example 17, the subject matter of Example 16 includes, wherein calculating the alternative route comprises utilizing a consensus mechanism among neighboring nodes to collaboratively select a new routing path.

In Example 18, the subject matter of Example 17 includes, wherein the reconfiguration protocol employs a weighted routing algorithm that utilizes the current network load, node energy levels, and historical reliability data to select the new routing path.

In Example 19, the subject matter of Examples 1-18 includes, wherein the mesh network's nodes use directional antennas to establish focused communication beams.

In Example 20, the subject matter of Examples 1-19 includes, synchronizing clocks among the nodes utilizing a time synchronization protocol.

Example 21 is a system for distributing random bitstreams for cryptographic key generation within a mesh network, the system comprising: a plurality of nodes forming a mesh network, the plurality of nodes including at least two of the following types: terrestrial stations, satellites, or high-altitude aircraft, the plurality of nodes configured to perform operations comprising: generating random bitstreams at the plurality of nodes within the mesh network; communicating the generated random bitstreams between the plurality of nodes to create a distributed pool of random bitstreams within the mesh network; and transmitting at least a subset of the distributed pool of random bitstreams to at least two communication endpoints; and at least two communication endpoints configured to perform operations comprising: independently from each other, generate a cryptographic key using the transmitted at least a subset of the distributed pool of random bitstreams; and establish a secure communication channel between distributing random bitstringsthe at least two communication endpoints using the generated cryptographic key.

In Example 22, the subject matter of Example 21 includes, wherein a first and second of the at least two communication endpoints are satellites in geosynchronous orbit and are both nodes in the mesh network.

In Example 23, the subject matter of Examples 21-22 includes, wherein the operations of generating of random bitstreams at the plurality of nodes comprises using quantum phenomena.

In Example 24, the subject matter of Example 23 includes, wherein the operations of communicating the generated random bitstreams comprises using quantum key distribution protocols to securely transmit the random bitstreams between nodes.

In Example 25, the subject matter of Examples 21-24 includes, wherein the communication endpoints are further configured to perform operations comprising selecting a subset of the distributed pool of random bitstreams to use in generating a cryptographic key based on synchronization signals within the mesh network.

In Example 26, the subject matter of Examples 21-25 includes, wherein the plurality of nodes are further configured to perform operations comprising encrypting the transmitted at least a subset of the distributed pool of random bitstreams using a previously established secure channel before sending to the communication endpoints.

In Example 27, the subject matter of Examples 21-26 includes, wherein the mesh network comprises a combination of geosynchronous Earth orbit (GEO) satellites and low Earth orbit (LEO) satellites.

In Example 28, the subject matter of Examples 21-27 includes, wherein the mesh network is configured to perform operations of utilizing frequency hopping or spread-spectrum communication techniques.

In Example 29, the subject matter of Examples 21-28 includes, wherein the cryptographic key generated at the communication endpoints is a symmetric key used for encrypting and decrypting messages.

In Example 30, the subject matter of Examples 21-29 includes, wherein the secure communication channel established is used for financial transactions.

In Example 31, the subject matter of Examples 21-30 includes, wherein the mesh network comprises high-altitude balloons, airplanes or drones.

In Example 32, the subject matter of Examples 21-31 includes, wherein the mesh network is configured to perform operations to automatically establish connections between nodes by executing a discovery protocol that identifies neighboring nodes based on signal strength and node capacity.

In Example 33, the subject matter of Example 32 includes, wherein the discovery protocol comprises operations of broadcasting beacon signals from nodes, with other nodes responding to the beacons to establish bidirectional communication links based on received signal quality indicators.

In Example 34, the subject matter of Examples 32-33 includes, wherein the discovery protocol further comprises an exchange of node capability data, including available bandwidth and power resources.

In Example 35, the subject matter of Examples 21-34 includes, wherein the mesh network is configured to perform further operations to execute a reconfiguration protocol that reroutes data transmission paths in response to node unavailability, maintaining network connectivity by identifying alternative pathways through operational nodes.

In Example 36, the subject matter of Example 35 includes, wherein the reconfiguration protocol comprises operations of monitoring an operational status of the nodes within the mesh network, and responsive to determining that a first node is not operational or cannot be communicated with, calculating an alternative route that does not include the first node.

In Example 37, the subject matter of Example 36 includes, wherein the operations of calculating the alternative route comprises utilizing a consensus mechanism among neighboring nodes to collaboratively select a new routing path.

In Example 38, the subject matter of Example 37 includes, wherein the reconfiguration protocol further comprises operations of utilizing a weighted routing algorithm that utilizes the current network load, node energy levels, and historical reliability data to select the new routing path.

In Example 39, the subject matter of Examples 21-38 includes, wherein the mesh network's nodes use directional antennas to establish focused communication beams.

In Example 40, the subject matter of Examples 21-39 includes, wherein the plurality of nodes are further configured to perform operations comprising synchronizing clocks among the nodes utilizing a time synchronization protocol.

Example 41 is a non-transitory machine-readable media for distributing random bitstreams for cryptographic key generation within a mesh network, the media comprising instructions, which when executed by hardware devices, cause the devices to perform operations comprising: generating random bitstreams at a plurality of nodes within the mesh network, wherein the plurality of nodes comprises at least two of the following types: terrestrial stations, satellites, or high-altitude aircraft; communicating the generated random bitstreams between the plurality of nodes to create a distributed pool of random bitstreams within the mesh network; transmitting at least a subset of the distributed pool of random bitstreams to at least two communication endpoints; independently from each other, generating a cryptographic key at the at least two communication endpoints using the transmitted at least a subset of the distributed pool of random bitstreams; and establishing a secure communication channel between distributing random bitstringsthe at least two communication endpoints using the generated cryptographic key.

In Example 42, the subject matter of Example 41 includes, wherein a first and second of the at least two communication endpoints are satellites in geosynchronous orbit and are both nodes in the mesh network.

In Example 43, the subject matter of Examples 41-42 includes, wherein the operations of generating of random bitstreams at the plurality of nodes comprises using quantum phenomena.

In Example 44, the subject matter of Example 43 includes, wherein the operations of communicating the generated random bitstreams comprises using quantum key distribution protocols to securely transmit the random bitstreams between nodes.

In Example 45, the subject matter of Examples 41-44 includes, wherein the operations further comprise selecting, at the communication endpoints, a subset of the distributed pool of random bitstreams to use in generating a cryptographic key based on synchronization signals within the mesh network.

In Example 46, the subject matter of Examples 41-45 includes, wherein the operations further comprise encrypting the transmitted at least a subset of the distributed pool of random bitstreams using a previously established secure channel before sending to the communication endpoints.

In Example 47, the subject matter of Examples 41-46 includes, wherein the mesh network comprises a combination of geosynchronous Earth orbit (GEO) satellites and low Earth orbit (LEO) satellites.

In Example 48, the subject matter of Examples 41-47 includes, wherein the mesh network is configured to perform operations of utilizing frequency hopping or spread-spectrum communication techniques.

In Example 49, the subject matter of Examples 41-48 includes, wherein the cryptographic key generated at the communication endpoints is a symmetric key used for encrypting and decrypting messages.

In Example 50, the subject matter of Examples 41-49 includes, wherein the secure communication channel established is used for financial transactions.

In Example 51, the subject matter of Examples 41-50 includes, wherein the mesh network comprises high-altitude balloons, airplanes or drones.

In Example 52, the subject matter of Examples 41-51 includes, wherein the operations further comprise automatically establishing connections between nodes by executing a discovery protocol that identifies neighboring nodes based on signal strength and node capacity.

In Example 53, the subject matter of Example 52 includes, wherein the operations further comprise broadcasting beacon signals from nodes as part of the discovery protocol, with other nodes responding to the beacons to establish bidirectional communication links based on received signal quality indicators.

In Example 54, the subject matter of Examples 52-53 includes, wherein the operations further comprise exchanging node capability data as part of the discovery protocol, including available bandwidth and power resources.

In Example 55, the subject matter of Examples 41-54 includes, wherein the operations further comprise executing a reconfiguration protocol that reroutes data transmission paths in response to node unavailability, maintaining network connectivity by identifying alternative pathways through operational nodes.

In Example 56, the subject matter of Example 55 includes, wherein the operations of executing the reconfiguration protocol comprises monitoring an operational status of the nodes within the mesh network, and responsive to determining that a first node is not operation or cannot be communicated with, calculating an alternative route that does not include the first node.

In Example 57, the subject matter of Example 56 includes, wherein the operations of calculating the alternative route comprises utilizing a consensus mechanism among neighboring nodes to collaboratively select a new routing path.

In Example 58, the subject matter of Example 57 includes, wherein the operations of executing the reconfiguration protocol comprises employing a weighted routing algorithm that utilizes the current network load, node energy levels, and historical reliability data to select the new routing path.

In Example 59, the subject matter of Examples 41-58 includes, wherein the mesh network's nodes use directional antennas to establish focused communication beams.

In Example 60, the subject matter of Examples 41-59 includes, the operations of utilizing a synchronization protocol to synchronizing clocks among the nodes.

Example 61 is at least one machine-readable medium including instructions that, when executed by processing circuitry, cause the processing circuitry to perform operations to implement of any of Examples 1-60.

Example 62 is an apparatus comprising means to implement of any of Examples 1-60.

Example 63 is a system to implement of any of Examples 1-60.

Example 64 is a method to implement of any of Examples 1-60.

What is claimed is:

1. A method for distributing random bitstreams for cryptographic key generation within a mesh network, the method comprising:
generating random bitstreams at a plurality of nodes within the mesh network, wherein the plurality of nodes comprises at least two of the following types: terrestrial stations, satellites, or high-altitude aircraft;
communicating the generated random bitstreams between the plurality of nodes to create a distributed pool of random bitstreams within the mesh network;
transmitting at least a subset of the distributed pool of random bitstreams to at least two communication endpoints;
independently from each other, generating a cryptographic key at the at least two communication endpoints using the transmitted at least a subset of the distributed pool of random bitstreams; and
establishing a secure communication channel between the at least two communication endpoints using the generated cryptographic key.

2. The method of claim 1, wherein a first and second of the at least two communication endpoints are satellites in geosynchronous orbit and are both nodes in the mesh network.

3. The method of claim 1, wherein the generating of random bitstreams at the plurality of nodes comprises using quantum phenomena.

4. The method of claim 3, wherein communicating the generated random bitstreams comprises using quantum key distribution protocols to securely transmit the random bitstreams between nodes.

5. The method of claim 1, wherein the method further comprises selecting, at the communication endpoints, a subset of the distributed pool of random bitstreams to use in generating a cryptographic key based on synchronization signals within the mesh network.

6. The method of claim 1, further comprising encrypting the transmitted at least a subset of the distributed pool of random bitstreams using a previously established secure channel before sending to the communication endpoints.

7. The method of claim 1, wherein the mesh network comprises a combination of geosynchronous Earth orbit (GEO) satellites and low Earth orbit (LEO) satellites.

8. A system for distributing random bitstreams for cryptographic key generation within a mesh network, the system comprising:
a plurality of nodes forming a mesh network, the plurality of nodes including at least two of the following types: terrestrial stations, satellites, or high-altitude aircraft, the plurality of nodes configured to perform operations comprising:
generating random bitstreams at the plurality of nodes within the mesh network;
communicating the generated random bitstreams between the plurality of nodes to create a distributed pool of random bitstreams within the mesh network; and
transmitting at least a subset of the distributed pool of random bitstreams to at least two communication endpoints; and
at least two communication endpoints configured to perform operations comprising:
independently from each other, generate a cryptographic key using the transmitted at least a subset of the distributed pool of random bitstreams; and
establish a secure communication channel between distributing random bitstringsthe at least two communication endpoints using the generated cryptographic key.

9. The system of claim 8, wherein the cryptographic key generated at the communication endpoints is a symmetric key used for encrypting and decrypting messages.

10. The system of claim 8, wherein the secure communication channel established is used for financial transactions.

11. The system of claim 8, wherein the mesh network comprises high-altitude balloons, airplanes or drones.

12. The system of claim 8, wherein the mesh network is configured to perform operations to automatically establish connections between nodes by executing a discovery protocol that identifies neighboring nodes based on signal strength and node capacity.

13. The system of claim 12, wherein the discovery protocol comprises operations of broadcasting beacon signals from nodes, with other nodes responding to the beacons to establish bidirectional communication links based on received signal quality indicators.

14. The system of claim 12, wherein the discovery protocol further comprises an exchange of node capability data, including available bandwidth and power resources.

15. A non-transitory machine-readable media for distributing random bitstreams for cryptographic key generation within a mesh network, the media comprising instructions, which when executed by hardware devices, cause the devices to perform operations comprising:
generating random bitstreams at a plurality of nodes within the mesh network, wherein the plurality of nodes comprises at least two of the following types: terrestrial stations, satellites, or high-altitude aircraft;
communicating the generated random bitstreams between the plurality of nodes to create a distributed pool of random bitstreams within the mesh network;
transmitting at least a subset of the distributed pool of random bitstreams to at least two communication endpoints;
independently from each other, generating a cryptographic key at the at least two communication endpoints using the transmitted at least a subset of the distributed pool of random bitstreams; and
establishing a secure communication channel between distributing random bitstringsthe at least two communication endpoints using the generated cryptographic key.

16. The non-transitory machine-readable media of claim 15, wherein the operations further comprise executing a reconfiguration protocol that reroutes data transmission paths in response to node unavailability, maintaining network connectivity by identifying alternative pathways through operational nodes.

17. The non-transitory machine-readable media of claim 16, wherein the operations of executing the reconfiguration protocol comprises monitoring an operational status of the nodes within the mesh network, and responsive to determining that a first node is not operation or cannot be communicated with, calculating an alternative route that does not include the first node.

18. The non-transitory machine-readable media of claim 17, wherein the operations of calculating the alternative route comprises utilizing a consensus mechanism among neighboring nodes to collaboratively select a new routing path.

19. The non-transitory machine-readable media of claim 18, wherein the operations of executing the reconfiguration protocol comprises employing a weighted routing algorithm that utilizes the current network load, node energy levels, and historical reliability data to select the new routing path.

20. The non-transitory machine-readable media of claim 15, wherein the mesh network's nodes use directional antennas to establish focused communication beams.
